(19) United States
(12) Patent Application Publication
(10) Pub. No.: US 2010/0084260 A1
(43) Pub. Date: Apr. 8, 2010

(54) LARGE SCALE MODULAR APPARATUS FOR SEPARATING CARBON PRODUCT FROM USED TIRE WITH MICROWAVE AND METHOD THEREOF

(76) Inventor: Charlie HONG, Happy Valley, OR (US)

Correspondence Address: PARK LAW FIRM, 3255 WILSHIRE BLVD, SUITE 1110, LOS ANGELES, CA, 90010, US

(21) Appl. No.: 12/244,613

(22) Filed: Oct. 2, 2008

(51) Int. Cl. B01J 19/08

(52) U.S. Cl. 204/157.15; 422/186

(57) ABSTRACT

An apparatus for decomposing used tires includes a loading chamber for loading a used tire, one or more modular processing units, and a finishing device that decomposes used tires that were incompletely decomposed in a processing chamber. In the loading chamber, oxygen is removed under a critical point that prevents explosion and nitrogen gas is injected. Used tires are conveyed in nitrogen atmosphere in the apparatus. The modular processing units comprises a processing chamber that decomposes a used tire with microwave, a lower door that loads a used tire, and a lower door drive device that moves the lower door up and down and rotates the lower door. A method for decomposing used tires with the apparatus is also provided.

### BACKGROUND OF THE INVENTION

The present invention relates to method and apparatus for separating carbon product and iron core from used tire. More particularly, the present invention relates to highly efficient method and apparatus for decomposing used tires using specific wavelength ranges of microwave in large scale.

Korean Patent No. 10-0469161-0000 discloses a decomposing method for used tires, which loads many (up to 70 tires) to a large reaction chamber in one time and radiates microwave. The method has not been realized due to high investment cost and that it is difficult for the microwave to propagate more than a single tire depth. Due to the inherent characteristic of microwave, the power substantially reduces at about 1 m in atmosphere.

Korean Patent No. 10-0645803-0000 discloses a method for radiating microwave while moving tires with a conveying device. A large amount of power for microwave radiation is required for proper decomposing of moving tires. Also this patent does not disclose how to handle incompletely decomposed tires.

Treating while the tire is moved continuously or discretely may cause inefficiency of decomposing since decomposing speed varies according to characteristic of tire, etc. In addition, incompletely decomposed tires may cause secondary pollution.

### SUMMARY OF THE INVENTION

The present invention contrives to solve the disadvantages of the prior art.

An objective of the invention is to provide method and apparatus that can reduce process time for decomposing used tires.

Another objective of the invention is to provide a method and apparatus for treating incompletely decomposed tires.

In order to achieve the above objective, the present invention provides method for decomposing used tires comprising steps of removing oxygen under a critical point that prevents explosion from a loading chamber and injecting nitrogen gas into the loading chamber, and decomposing a used tire in a processing chamber by applying microwave. A used tire is loaded into the loading chamber. Decomposing is done in one or more modular processing unit. The used tire is conveyed in nitrogen atmosphere during the entire process.

Injecting nitrogen gas is done during decomposing a used tire in the processing chamber and before a used tire is loaded into the processing chamber.

The method further includes a finish processing that decomposes used tires that were incompletely decomposed in the step of decomposing.

The present invention also provides an apparatus for decomposing used tires that includes a loading chamber for loading a used tire, and one or more modular processing units. In the loading chamber, oxygen is removed under a critical point that prevents explosion and nitrogen gas is injected. Each of the modular processing units comprises a processing chamber that decomposes a used tire with microwave. The used tire is conveyed in nitrogen atmosphere.

Nitrogen gas is injected into the loading chamber during decomposing a used tire in the processing chamber and before a used tire is loaded into the processing chamber.

The modular processing unit further comprises a lower door that loads a used tire, a lower door drive device that moves the lower door up and down and rotates the lower door, and a hydraulic opening/closing device that opens/closes the lower door.

The apparatus further comprises a finishing device that decomposes used tires that were incompletely decomposed in the processing chamber. The finishing device comprises a high frequency wave channel and/or a microwave channel.

The apparatus further comprises a conveying device that conveys used tires in nitrogen atmosphere, a conveyor belt that conveys carbon black and iron cores that are decomposed from used tires to a storage tank, a magnetic separator that separates iron cores and carbon black, a cooling plate that converts gas generated by decomposing into liquid oil, an automatic pressure relief valve that prevents high gaseous pressure for safety, an oxygen sensor that checks oxygen amount in the processing chamber for preventing explosion, a microwave leak sensor that senses leak of microwave, and a sprinkler that is provided inside the apparatus.

The advantages of the present invention are: (1) the decomposing device can increase or decrease individual modules so that processing capacity can be estimated and controlled; (2) pre-maintenance, which is essential in mass processing, is facilitated; (3) while prior art required injecting gas for preventing explosion, decomposing with microwave, and removing oil vapor resulting in pre-processing and post-processing time that take 60% or more of the entire processing time, the present invention only adds tire loading time before decomposing process with microwave, and removing residue after the decomposing process increasing productivity more than two times; (4) the present invention removes concerns for explosion and environmental pollution.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIGS. 1 and 2 are elevation views showing an apparatus for decomposing used tires by prior art;

FIG. 3A is a side elevation views that show an apparatus for decomposing used tires according to the present invention;

FIG. 3B is a front elevation views that show the apparatus;

FIG. 4A is a plan view showing a multi-module apparatus according to the present invention;

FIG. 4B is an elevation view that shows the multi-module apparatus; and

FIG. 5 is a perspective view of the multi-module apparatus.

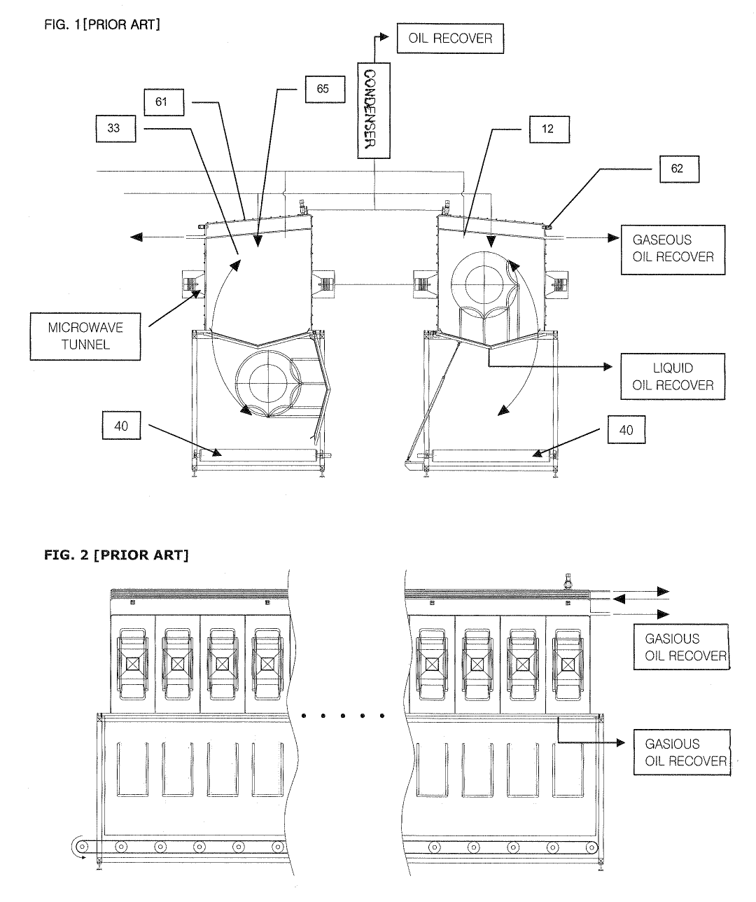

### DETAILED DESCRIPTION OF THE INVENTION

The present invention is an improvement over the method and apparatus for separating carbon products from used tires disclosed in U.S. patent application Ser. No. 11/686,175, filed on Mar. 14, 2007, the disclosure of which is incorporated by reference as if it is fully set forth herein.

Method and apparatus for decomposing tires by prior art had disadvantages that long processing time is required to perform step of preparation for preventing explosion before main processing, step of main processing, and step of removing oil vapor. The step of preparation for preventing explosion requires several minutes (1˜9 minutes) for injecting nitrogen gas. The steps were required since the processing modules were directly connected to the atmosphere.

A microwave processing chamber processes used tires that have been conveyed in nitrogen atmosphere for a predetermined process time. Processed tires are rotated upside down, and placed on a conveyor belt. Unprocessed used tires are loaded, and the microwave processing chamber is prepared for processing. If there is incompletely processed portion in the tires placed on the conveyor belt, the tires undergo finishing treatment by passing through a high-frequency wave part and a microwave part. Carbon black and iron cores are conveyed into a storage, and separated by a magnet and stored separately.

One tire loading chamber and a plurality of modular reaction chambers are provided. The capacity is decided by the number of the reaction chambers. While prior art processes many tires (up to 70) in one batch in a large reaction chamber, and the resulting products are treated together, the present invention collects resulting products that passed through unit process with a conveying device, and post treat them collectively.

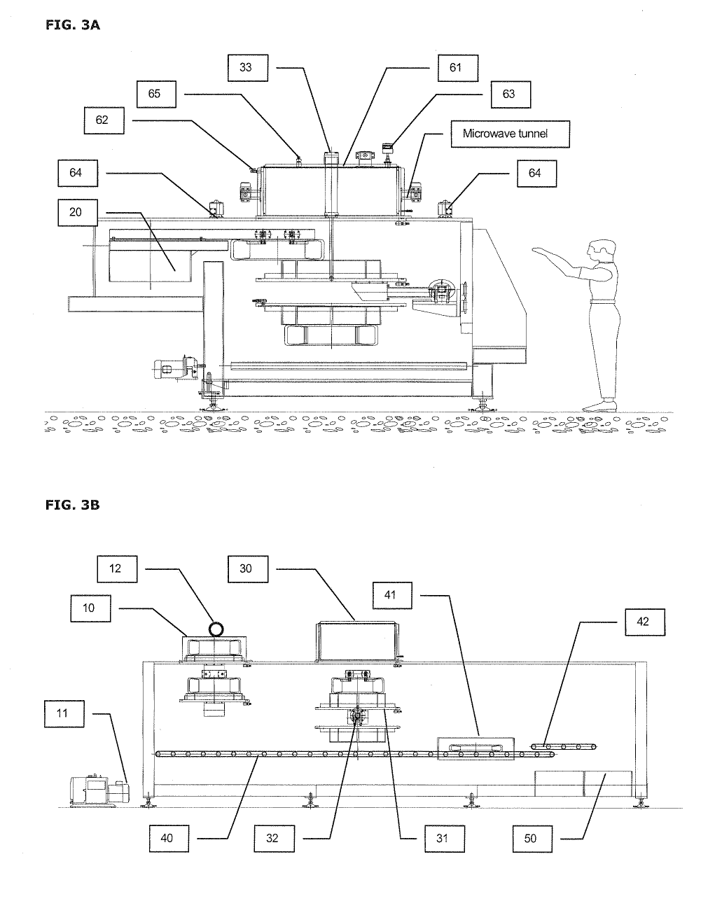

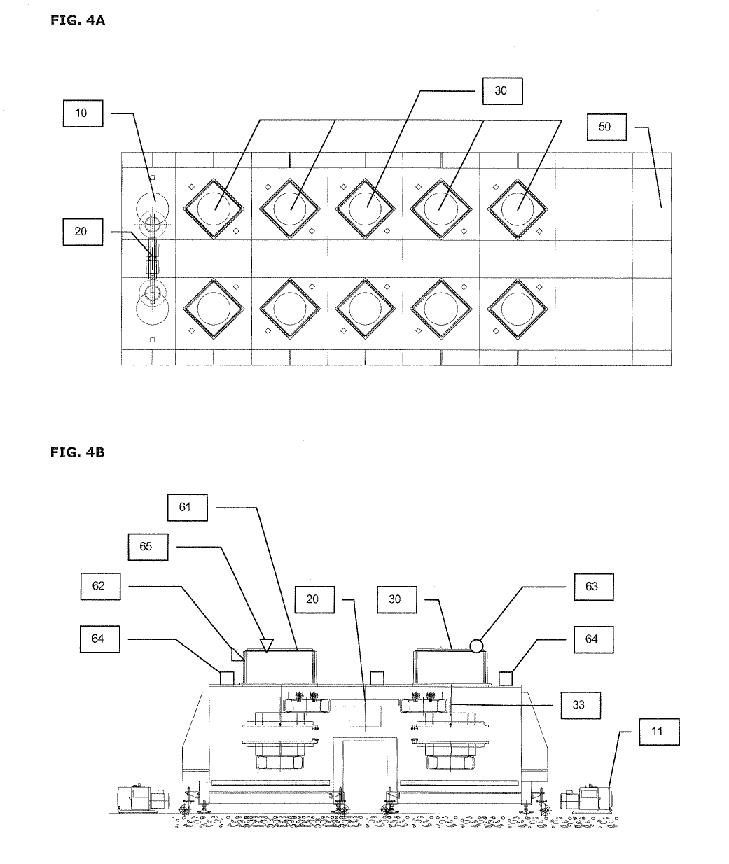

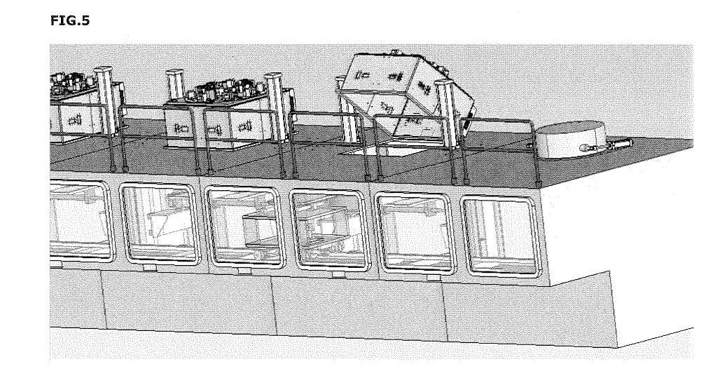

FIGS. 3A, 3B, 4A and 4B show a tire decomposing apparatus of the present invention that includes a loading chamber 10 into which used tires are loaded, a vacuum pump 11, a nitrogen gas supply 12, a conveying device 20 that conveys used tires in nitrogen atmosphere, a processing chamber 30 that decomposes used tires, a lower door 31 that loads the used tire thus conveyed, prevents leak of microwave and handles recovered oil, a lower door drive device 32 that moves the lower door up and down and rotates the lower door, a hydraulic opening/closing device 33 that opens/closes the door on which heavy tires are attached, a conveyor belt 40 that conveys carbon black and iron cores to a predetermined space after processing, a finishing device 41 that processes incompletely decomposed tires, a magnetic separator 42 that separates iron cores and carbon black, and a storage tank 50. The present invention also provides safety devices including a cooling plate 61 that converts gas generated by decomposing into liquid oil, an automatic pressure relief valve 62 that prevents high gaseous pressure for safety, an oxygen sensor 63 that checks oxygen amount in the processing chamber for preventing explosion, a microwave leak sensor 64 that senses leak of microwave, and a sprinkler 65 that is provided inside the apparatus.

The decomposing apparatus has a modular construction in which required number of decomposing modules are arranged per the amount of used tires that need decomposition. Each decomposing module comprises the processing chamber 30, the lower door 31, the lower door drive device 32, and the hydraulic opening/closing device 33.

FIG. 5 shows how a used tire is conveyed inside the decomposing apparatus and the modular decomposing units provided along the decomposing apparatus.

Vacuum is created in the loading chamber 10 until oxygen is reduced to the critical point that prevents explosion and nitrogen is injected during the time that tire is processed in the processing chamber 30, and before the tire is loaded into the processing chamber. In this way, the time that was required for preparation for preventing explosion is eliminated.

The tire is conveyed in nitrogen atmosphere and in a sealed space when the tire or the remains after the tire is processed are conveyed along the loading chamber, the processing chamber and to the storage tank. In this way, explosion is prevented, and oil gas leak is blocked, thereby removing the necessity of wait time for oil gas removing.

When the tire is incompletely decomposed after processing in the processing chamber, such remains are completely decomposed by subsequent processing that includes passing the remains through a high frequency wave tunnel and a microwave tunnel.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for decomposing used tires comprising steps of:
a) removing oxygen under a critical point that prevents explosion from a loading chamber and injecting nitrogen gas into the loading chamber, wherein a used tire is loaded into the loading chamber; and
b) decomposing a used tire in a processing chamber by applying microwave;
wherein decomposing is done in one or more modular processing unit, wherein the modular processing unit comprises the processing chamber, wherein the used tire is conveyed in nitrogen atmosphere during the entire process.

2. The method of claim 1, wherein injecting nitrogen gas is done during decomposing a used tire in the processing chamber and before a used tire is loaded into the processing chamber.

3. The method of claim 1, wherein the modular processing unit further comprises a lower door that loads a used tire, and a lower door drive device that moves the lower door up and down and rotates the lower door.

4. The method of claim 1, further comprising a finish processing that decomposes used tires that were incompletely decomposed in the step of decomposing.

5. The method of claim 4, wherein the incompletely decomposed tires pass through a high frequency wave channel and/or a microwave channel.

6. An apparatus for decomposing used tires comprising:
a) a loading chamber for loading a used tire, wherein oxygen is removed under a critical point that prevents explosion and nitrogen gas is injected; and
b) one or more modular processing units, wherein each of the modular processing units comprises a processing chamber that decomposes a used tire with microwave;
wherein the used tire is conveyed in nitrogen atmosphere.

7. The apparatus of claim 6, wherein nitrogen gas is injected into the loading chamber during decomposing a used tire in the processing chamber and before a used tire is loaded into the processing chamber.

8. The apparatus of claim 6, wherein the modular processing unit further comprises a lower door that loads a used tire, and a lower door drive device that moves the lower door up and down and rotates the lower door.

9. The apparatus of claim 8, wherein the modular processing unit further comprises a hydraulic opening/closing device that opens/closes the lower door.

10. The apparatus of claim 6, further comprising a finishing device that decomposes used tires that were incompletely decomposed in the processing chamber.

11. The apparatus of claim 10, wherein the finishing device comprises a high frequency wave channel and/or a microwave channel.

12. The apparatus of claim 10, further comprising a conveying device that conveys used tires in nitrogen atmosphere, a conveyor belt that conveys carbon black and iron cores that are decomposed from used tires to a storage tank,

13. The apparatus of claim 12, further comprising a magnetic separator that separates iron cores and carbon black, a cooling plate that converts gas generated by decomposing into liquid oil, an automatic pressure relief valve that prevents high gaseous pressure for safety, an oxygen sensor that checks oxygen amount in the processing chamber for preventing explosion, a microwave leak sensor that senses leak of microwave, and a sprinkler that is provided inside the apparatus.
